(19) United States
(12) Patent Application Publication
(10) Pub. No.: US 2008/0113609 A1
(43) Pub. Date: May 15, 2008

(54) Combined Supply and Exhaust Apparatus

(75) Inventor: Gregory Allen Ehlers, New Port Richey, FL (US)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Richmond, VA (US)

(21) Appl. No.: 11/559,648

(22) Filed: Nov. 14, 2006

(51) Int. Cl. F16L 9/19; F16L 9/18; F28F 13/12; F16L 55/07; F24F 7/04

(52) U.S. Cl. 454/241; 138/115; 138/114; 138/116; 138/38; 138/40

(57) ABSTRACT

A combined supply and exhaust apparatus for an air using appliance is provided. The combined supply and exhaust apparatus includes air supply and air exhaust passages. The air supply and air exhaust passages extend between inlets and outlets. A common wall separates the air supply passage from the air exhaust passage. The air supply passage supplies air to the appliance and the air exhaust passage exhausts air from the appliance.

### FIELD OF THE INVENTION

This invention generally relates to clothes dryers and, more particularly, to air supply and air exhaust apparatuses for use with clothes dryers.

### BACKGROUND OF THE INVENTION

With increasing energy costs, consumers are becoming more and more energy conscious. As such, consumers are demanding more energy efficiency from their appliances and the homes in which they live. Many appliance manufacturers have responded by attempting to increase their products' energy efficiency. However, no matter how efficient some appliances are made, the use of the appliance may be inefficient by causing other less efficient devices to also activate.

One such example is the use of a dryer for drying moist articles or goods, commonly referred to as a clothes dryer. Common practice with clothes dryers is to intake air from the room in which the clothes dryer is operating, heat it, pass it through the moist goods housed in a drying chamber, also referred to as a drum, and then exhaust it from the clothes dryer through an exhaust duct to the exterior of the building. During this process, it is common for as much as 150 cubic feet of air to be exhausted from the interior of the building to the exterior of the building per minute of operation. With typical drying cycles lasting approximately 45 minutes in length, the average clothes dryer can consume, on average, 6,750 cubic feet of air during a single cycle. This is the equivalent volume of air in seven rooms having eight foot ceilings and ten foot by twelve foot dimensions. As the air from the interior of the building is exhausted to the exterior of the building, the air that previously occupied the building is replaced by unconditioned air from the exterior of the building. Typically, this replacement air enters the building through doors, windows, cracks and other air passages fluidly communicating the interior of the building with the exterior.

This replacement of such a substantial volume of conditioned air from within the building with unconditioned air from the exterior of the building typically causes the condition of the air within the building to change. This, in turn, causes the heating, ventilating, and air conditioning system (HVAC system) of the building to activate to return the interior of the building to a pleasing condition. Unfortunately, the HVAC system is the most costly system in most buildings to operate. Thus, even if the individual operation of the clothes dryer can be made more efficient, the use of the clothes dryer causes the HVAC system to activate, reducing the overall efficiency of the clothes drying process.

Other problems exist with current clothes dryers. For example, the exhaust duct that vents the exhaust air from the clothes dryer to the exterior of the building can become plugged with lint or other particulate and catch fire causing structural damage to the building. Further, the exhaust pipes themselves can become extremely hot as a result of the hot exhaust air flowing through the pipes which can damage walls, wires, and other structure of the building that are positioned proximate the exhaust ducts. In addition, as the clothes dryer expels the humid warmed air from the building, the humid warm air takes with it a large quantity of heat energy that has been produced by the dryer to dry the clothes. This heat energy stored in the exhausted humid warm air is merely dumped into the exterior environment and wasted further reducing the overall operating efficiency.

Thus, there is a need in the art for an air supply and exhaust system that reduces the amount of conditioned air that is expelled from the interior of the building during operation of the dryer, increases safety, and more efficiently conserves the heat energy that is produced to dry the moist goods.

### BRIEF SUMMARY OF THE INVENTION

In view of the above, a new and improved supply and exhaust apparatus for supplying and exhausting air to an air using appliance is provided. An embodiment of the apparatus provides improved safety by insulating an exhaust air passage of the apparatus with an supply air passage by having the exhaust air passage passing through the supply air passage. The air gap between the outer passage and the inner passage reduces the potential for a fire when objects come into contact with the supply and exhaust apparatus. Further, if a fire should occur in the air exhaust passage from lint or other byproducts of the drying process, the concentric configuration reduces the hazard of the fire on walls of the building.

Further, in an embodiment, the exhaust air passage and supply air passage are separated by thermally conductive material allowing heat transfer between the two passages. As such, incoming air may be preheated by hot exhaust air. To improve the heat transfer capability, heat transfer fins are employed in embodiments to improve extraction and transfer of waste heat energy of the exhausted air stream. This configuration allows heat energy that is normally lost during standard drying cycles to be recaptured, increasing the energy efficiency of the drying system incorporating the supply and exhaust apparatus.

In a further embodiment, the supply and exhaust system reduces the amount of indoor conditioned air used during the drying process increasing the overall energy efficiency of the drying process.

In one embodiment, the invention provides a combined supply and exhaust apparatus for an air using appliance including an air flow duct including two air flow passages. The air flow passages extend between two inlets and two outlets, respectively. Preferably, the inlets and outlets are concentrically located to one another so that only a single hole is needed to communicate with the exterior of the building. A common wall separates the first air flow passage from the second air flow passage. One air flow passage is configured as an air supply passage to supply air to the appliance. The other air flow passage is configured as an air exhaust passage to exhaust air from the appliance.

In another embodiment of a combined supply and exhaust apparatus for an air using appliance, the apparatus includes an air flow duct having two air flow passages being separated by a common wall. A first supply and exhaust manifold is mounted to a first end of the air flow duct. The first supply and exhaust manifold forms a first outlet of the first flow passage and a second inlet of the second flow passage. A second intake and exhaust manifold is mounted to an opposite end of the air flow duct. The second intake and exhaust manifold forms a first inlet of the first flow passage and a second outlet of the second flow passage. The first flow passage is configured as an air supply passage for supplying air to the appliance therethrough and the second flow passage is configured as an air exhaust passage for exhausting air from the appliance therethrough.

In an embodiment, existing dryer ducts can be retrofit to take advantage of the features of the combined supply and exhaust apparatus. In such an embodiment, a separate smaller air supply means can be installed within the existing duct. Alternatively, the combined supply and exhaust apparatus can be retrofit to work with standard dryers. The combined supply and exhaust apparatus can be used to provide a fresh air induction path directly to the room or environment in which the dryer is located to prevent conditioned air from being drawn from the rest of the building. Such a configuration includes dampers to eliminate free air flow through the apparatus reducing the loss of conditioned air to the exterior of the building when the drying process is inactive.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified side view illustration of a dryer positioned within a building and including an supply and exhaust system according to the teachings of the present invention;

FIG. 2 is a simplified end view of an embodiment of a dual flow duct for a dryer according to the teachings of an embodiment present invention.

FIG. 3 is a simplified cross-sectional illustration of the dryer of FIG. 1;

FIGS. 4 and 5 are simplified side views of additional embodiments of dyers and drying systems according to the teachings of the present invention;

FIGS. 6 and 7 are a simplified end views of additional embodiments of dual flow ducts according to the teachings of the present invention; and

FIG. 8 is a simplified cross-sectional illustration of the connection between the dual flow duct and a dryer according to the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

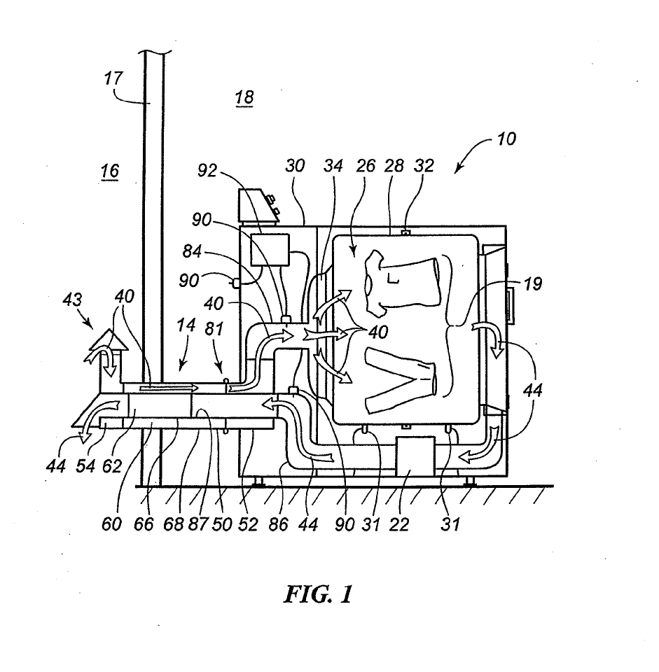

Turning now to the figures, FIG. 1 illustrates a dryer 10 and a dual flow duct 14 according to the teachings of one embodiment of the present invention. The dryer 10 advantageously draws air from the exterior 16 of the building 17 rather than conditioned air from the interior 18 of the building 17 to dry moist goods 19 within the dryer 10. This configuration significantly reduces the amount of conditioned air within the building 17 that is needlessly exhausted from the building 17 during a drying cycle and lost to the exterior 16 of the building 17. Advantageously, by reducing the amount of conditioned air that is exhausted from the building 17, the same amount of exterior, unconditioned air, is prevented from entering the building 17. By reducing the amount of unconditioned air that is added to the building 17, the internal conditions of the building 17 are not significantly altered during the drying process, thereby reducing the work load, and energy use, of the HVAC system of the building (not shown).

According to the teachings of one embodiment, the dryer 10 functions to dry moist goods 19 such as clothing, towels, rags, and the like placed within the dryer 10 by passing air through and/or across the material of the moist goods 19. As such, the dryer 10 includes a blower 22, shown schematically, that forces air through the dryer 10 and in contact with the moist goods 19. More particularly, in an embodiment, the blower 22 draws air through an air flow passage ducted through the dryer 10 that directs air through the moist goods 19 to be dried.

One portion of the air flow passage includes a drying chamber 26 in which the moist goods 19 are placed during the drying cycle. In the illustrated embodiment, the drying chamber, indicated generally by reference numeral 26, is provided by a drum 28 that is rotatably supported within the outer housing 30 of the dryer 10. The drum 28 rotates during the drying cycle causing the moist goods 19 that are located therein to tumble while drying. The tumbling action beneficially allows individual pieces of the moist goods 19 to separate facilitating the passage of drying air through and across the moist goods 19 to increase the evaporating action of the drying air, thereby increasing the rate of moisture removal from the moist goods 19. The drum 28 is typically rotatably supported by a plurality of rollers 31 and is rotatably driven by a belt 32 connected to and powered by an electric motor (not shown). In an embodiment, the electric motor that drives the drum 28 also drives the blower 22.

In an embodiment, the dryer 10 includes a heater, shown in a simplified manner at reference number 34. The heater 34 is positioned within the air flow passage passing through the dryer 10 upstream from the drum 28. The heater 34 heats the air prior to the air passing through the drum 28 and, consequently, prior to the air passing through the moist goods 19. Warm air can retain and absorb more moisture from the moist goods 19 and thereby reduce the amount of air and the length of time required to dry the moist goods 19. The heater 34 may be any practicable heater and may include such heaters as electrically resistive heaters, gas fired heaters, and the like.

In an embodiment, the blower 22 draws the “drying” air, indicated by arrows 40, into the dryer 10 directly from the exterior 16 of the building 17. The drying air 40 is then heated and passed through the moist good 19 to dry the moist goods 19. This configuration of using exterior air as the drying air 40 rather than conditioned air from within the interior 18 of the building 17 reduces the amount of energy used thereby increasing the overall energy efficiency of the process. Particularly, this configuration reduces the amount of conditioned air that is consumed by the dryer and expelled from the building 17. This, in turn, reduces the amount of non-conditioned air that enters the building from the outside, which, in turn, reduces the load on the HVAC system (not shown) to maintain the desired temperature and humidity levels of the building 17. As such, a method of drying moist goods 19 using a dryer 10 and dual flow duct 14 disclosed herein by drawing air from the exterior 16 of the building 17 through the dual flow duct 14 rather than drawing air from the interior of the building is highly beneficial.

Further, this configuration reduces the amount of energy that is wasted during warm periods by exhausting air that previously had been conditioned which required energy to cool the air. As noted previously, the HVAC system of a building is one of the most costly systems in a building to operate. Any reduction in unnecessary operation of the HVAC system will beneficially increase overall efficiency and energy consumption of the building as a whole.

As the drying air 40 passes through the drying chamber 26 and the moist goods 19, the previous lower humidity drying air 40 absorbs moisture from the moist goods 19 and becomes humid stale exhaust air, indicated by arrows 44 and proceeds to be exhausted from the dryer 10. The exhaust air 44 passes through an exhaust air portion of the air passage of the dryer 10 downstream from the drying chamber 26 to the dual flow duct 14. The dual flow duct 14, in part, fluidly communicates the exhaust portion of air passage with the exterior 16 of the building 17 and as such allows the exhaust air 44 to be exhausted from the dryer 10 to the exterior 16 of the building 17.

More particularly, in an embodiment, a first end 50 of the dual flow duct 14 connects to an air intake and exhaust manifold 52 of the dryer 10, and the second, opposite, end 54 of the dual flow duct is positioned in and in fluid communication with the exterior 16 of the building 17. In an embodiment, the second end 54 of the dual flow duct 14 is connected to a second air intake and exhaust manifold 43 positioned outside of the building 17. As is illustrated, the second air intake and exhaust manifold 43 is configured to prevent rain or other debris from entering the dual flow duct 14. This can be accomplished by including canted roughs, tops or covers over the openings through which drying air 40 and exhaust air 44 enter and exit, respectively, the second air intake and exhaust manifold 43. Additionally, the openings in the second air intake and exhaust manifold may include grates, grills, mesh and the like to prevent debris from entering the openings.

The dual flow duct 14 includes two air flow passages including an air supply passage 60 for drawing in the drying air 40 and an air exhaust passage 62 for exhausting the exhaust air 44. In an embodiment, the air supply passage 60 and air exhaust passage 62 are positioned proximate one another such that the two air flow passages are separated by a common wall 66. As such, the air supply passage 60 and the air exhaust passage 62 are formed in a common structure, namely dual flow duct 14. As such, the air that is drawn in through the air supply passage 60 and the air exhausted through the air exhaust passage 62 flow in the common air flow structure, dual flow duct 14.

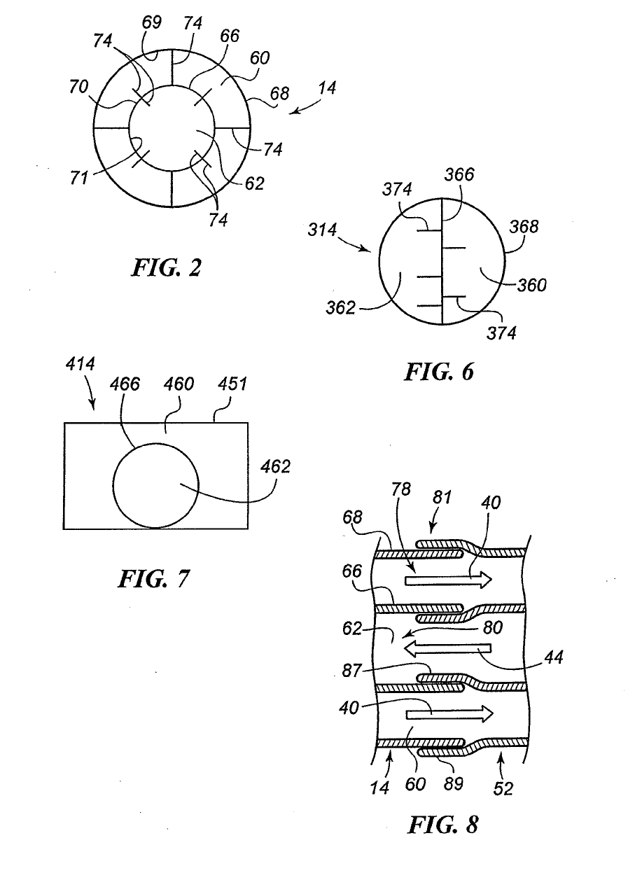

In an embodiment, as illustrated in FIGS. 1 and 2, the air supply passage 60 and air exhaust passage 62 are concentric with one another. In such an embodiment, the dual flow duct 14 is provided by an outer annular wall 68 and the common wall 66 that forms an inner annular wall, with the outer wall 68 and common wall 66 concentrically aligned. In this configuration, the space between an inner surface 69 of the outer annular wall 68 and an outer surface 70 of the common wall 66 provides the air supply passage 60. The inner surface 71 of the common wall 66 entirely defines the air exhaust passage 62. When drying moist article 19 using a method of the present invention, drying air 40 and exhaust air 44 are drawn in and exhausted through the dual flow duct 14 in a concentric manner, such that the drying air 40 flows in an opposite direction as the exhaust air 44 and through the radially outer passage.

In an embodiment, the common wall 66 is made from a thermally conductive material such as metal. Using a common wall 66 of a thermally conductive material beneficially increases the efficiency of the dryer 10. In such a configuration, some of the heat energy stored by the exhaust air 44 passing through the air exhaust passage 62 is dissipated to the drying air 40 drawn in through the air supply passage 60 through the thermally conductive common wall 66. The transfer of heat energy from the exhaust air 40 to the drying air 44 reduces the amount of heat energy required to be added to the drying air 44 by the heater 34.

As it is beneficial to have as much heat energy transferred from the exhaust air 44 to the drying air 40 as possible, an embodiment of the present invention includes heat transfer structures, such as heat pipes and/or, as illustrated, heat transfer fins 74 that extend from the outer and inner surface 70, 71 of the common wall 66 of the dual flow duct 14. The heat transfer fins 74 increase the amount of surface area for the air flowing through the air intake and air exhaust passages 60, 62 to contact and impinge further increasing the amount of heat that will be dissipated from the exhausted air 44 and will be absorbed by the drying air 40. Further, the heat transfer fins 74 may be used to mount, position and/or support the common wall 66 within the outer annular wall 68. In such an embodiment, the heat transfer fins 74 extend entirely from the outer surface 70 of the common wall 66 to the inner surface 69 of the outer annular wall 68.

Condensation may occur as the warm humid exhaust air 44 reduces in temperature as it dissipates heat energy to the drying air 44. Therefore, in an embodiment, the outer annular wall 68 and inner common wall 66 are preferably made from a stainless or corrosion resistant material to prevent any condensation that forms thereon from damaging the walls 66, 68, which may include metal or plastic.

The concentric configuration, having the air exhaust passage 62 passing through the air supply passage 60, has several beneficial features. First, as noted previously, the dual flow duct 14 functions as a dual flow heat exchanger. With the air exhaust passage 62 positioned within the air supply passage 60, the entire surface area of the common wall 66 that surrounds the air exhaust passage 62 is in thermal communication with the exhaust air 44 and drying air 40 on opposite sides of the common wall 66. Thus, any heat energy that is dissipated from the exhaust air 44 will be transferred to the drying air 40. It should be noted that the illustrated embodiment uses walls 66, 68 having round cross-sections, one of skill in the art will recognize that the walls 66, 68 are not so limited in shape and can be any shape such as square, rectangular, oval, and the like. Furthermore, as the outer annular wall 68 and common wall 66 are both have the same shape, it is not required that both walls have the same shape. For example and as illustrated in an alternative embodiment of a dual flow duct 414 in FIG. 7, the outer wall 451 is rectangular while the inner common wall 466 is round having the air supply passage 460 and air exhaust passage 462 defined between the outer wall 451 and within the common wall 466, respectively.

As the wall forming the air exhaust passage can become very hot, it is a benefit of the configuration illustrated in FIG. 1 that the air supply passage 60 performs the further function of insulating the common wall 66, which defines the air exhaust passage 62 from its surroundings. This increases safety by preventing the air exhaust passage from damaging any infrastructural components of the building that are proximate to the dual flow duct 14. Similarly, the dual wall configuration prevents individuals from getting injured upon accidentally contacting the outer surface of the exhaust duct because the individual does not touch the outer surface of the exhaust air passage. Additionally, if a fire should occur in the exhaust air passage 62 because of excess lint or by products of the drying process, the double wall configuration may reduce the hazard of the fire spreading to interior walls or other structure of the building 17.

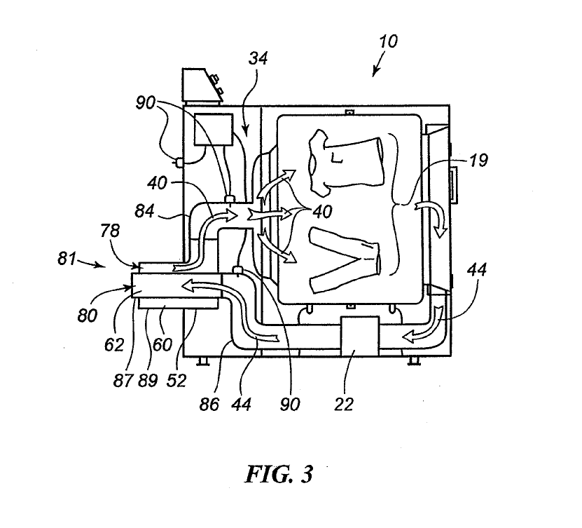

As indicated previously, the dryer 10 includes an air intake and exhaust manifold 52 for connecting the dual flow duct 14 to the dryer 10. As best illustrated with reference to FIGS. 1 and 3, the air intake and exhaust manifold 52 forms the inlet 78 and the outlet 80 for the air passage passing through the dryer 10. The inlet 78 and outlet 80 are formed in a duct connection end 81 of the air intake and exhaust manifold 52 that is configured to be connected to a dual flow duct 14, as shown in FIG. 1. Additionally, the air intake and exhaust manifold 52 functions to separate the air supply passage 60 from the air exhaust passage 62. Furthermore, the air intake and exhaust manifold 52 communicates the air supply passage 60 with the portion of the air flow passage within the dryer upstream from the drying chamber 26 and the air exhaust passage 62 to the portion of the air flow passage within the dryer 10 downstream of the drying chamber 26. As illustrated, in an embodiment, this is accomplished by a first duct 84 interconnecting the air supply passage 60 portion of the air intake and exhaust manifold 52 to the heater 34. A second duct 86 interconnects the air exhaust passage 62 of the air intake and exhaust manifold 52 to the blower 22 such that the exhaust air 44 exiting the blower 22 is directed to the air intake and exhaust manifold 52 such that the exhaust air 40 is exhausted to the air exhaust passage 62. The ducts 84, 86 may be connected to the air intake and exhaust manifold 52 by standard duct connections.

In an embodiment, the duct connection end 81 of the air intake and exhaust manifold 52 is configured of easy attachment to the dual flow duct 14. In an embodiment and as illustrated in FIG. 3, the air intake and exhaust manifold 52 has an inner flange 87 that extends outward beyond an end of an outer flange 89. Alternatively, the dual flow duct 14 could have the ends of the common and outer walls 66, 68 offset.

Preferably, the flanges are configured to minimize resistance on the fresh air 40 flowing through the air supply passage 60 as it passes from the dual flow duct 14 to the air intake and exhaust manifold 52 as well as the exhaust air 44 flowing from the air intake and exhaust manifold 52 to the dual flow duct 14 through the air exhaust passage 62. To minimize the air resistance and as illustrated in FIG. 8, the inner flange 87 can be configured to slide into the common wall 66 of the dual flow duct 14 and the outer flange 89 can be configured to slide around and receive the outer wall 68. This can be accomplished by having the flanges 87, 89 of the air intake and exhaust manifold 52 tapered, or by having the ends of the walls 66, 68 of the dual flow duct 14 tapered, or any combination thereof. Tapering can include having a larger continuous diameter sized to receive the corresponding portion of the other component for easy mating between the dual flow duct 14 and the air intake and exhaust manifold 52 as well as continuously varying radii such as in a chamfer. The second air intake and exhaust manifold may be similarly configured to mount to an end of the dual flow duct 14.

The dryer 10 may further include sensors 90 for sensing characteristics of the drying air 40 and exhaust air 44 flowing through the dryer 10 as well as the air supply and air exhaust passages 60, 62. These sensors 90 can sense characteristics such as air temperature, flow rate, presence of hazardous gases, humidity and the like. The sensors 90 can operably communicate with a controller 92 or other logic device for operably controlling the dryer 10 in response to the sensed characteristics. Particularly, the sensed condition of the air can be compared with predetermined or user determined values. Air temperature and flow rate sensors can be beneficial in helping determine if any portions of the air flow passages are plugged or if the dryer 10 is functioning properly. In such a case, the dryer 10 and its controller 92 may be configured to activate an alarm (not shown) or cease operation until the dryer 10 or dual flow duct 14 has been inspected and cleared.

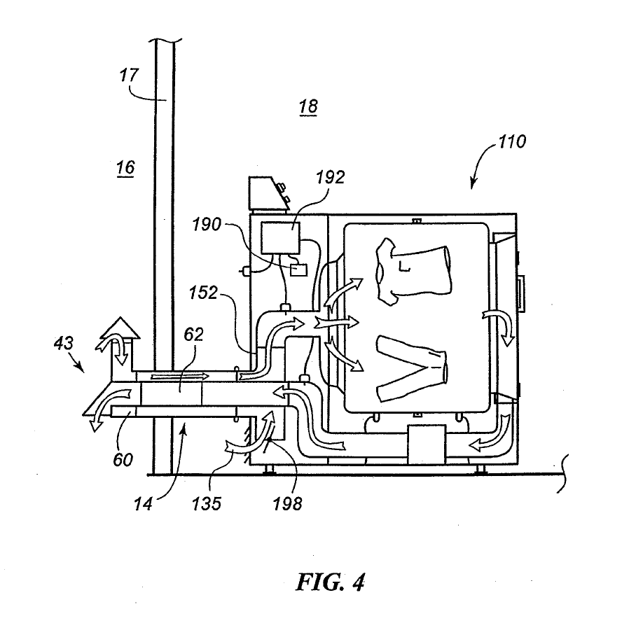

With reference to FIG. 4, in another embodiment, the drying air portion of the air intake and exhaust manifold 152 includes a damper 198 that may be opened if a sensor 190 senses the presence of harmful gases proximate the dryer 110, such as carbon monoxide. Upon sensing the presence of harmful gas, the controller 192 actuates the damper 198 to an open position. The dryer draws the air 135, which includes the hazardous gasses, from the localized environment of the dryer 110, i.e. from the interior 18 of the building 17 and exhausts the hazardous gasses out of the building 17 as exhaust air through the air exhaust passage 62. Additionally, if hazardous gas is sensed, the controller 192 of the dryer 110 may be programmed to lock out operation or activation of the dryer 110 until the controller 192 is reset and/or the presence of hazardous gas is eliminated.

Although existing ductwork in buildings does not have dual passages for providing an air supply passage and an air exhaust passage, existing structure can be retro fit to form embodiments of dual flow duct work. Rather than removing the existing ductwork and replacing it with new dual flow ducts, existing ducts can be used along with a second duct pipe that is installed in the structure in addition to the existing ductwork. After the new duct pipe is installed in the dwelling, the combination of old and new ducts can function as explained previously, i.e. the old duct will continue to be used to exhaust the dryer, while the new duct will supply outside air to the dryer.

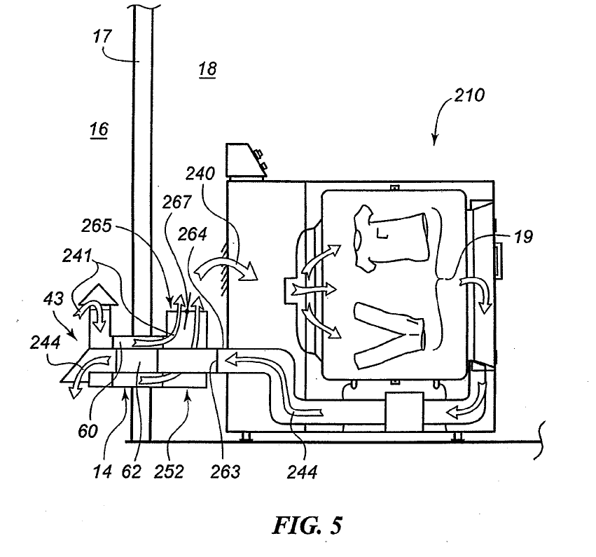

In a further embodiment of the present invention, illustrated in FIG. 5, the embodiment incorporates a standard dryer 210 that draws drying air 240 directly from the room of the building 17 housing the dryer 210. This embodiment may be used by retrofitting existing ductwork with a second passage as explained previously or with newly installed dual flow duct previously described prior to acquiring a dryer configured to communicate with the dual flow duct 14.

As explained previously, standard dryers draw drying air directly from the ambient air within the room housing the dryer and then exhaust it to the exterior of the building. The ambient air directly surrounding the dryer is then replenished with other conditioned air from within the building. Typically, this air enters through the door or gaps around the door leading to the room. The exhaust air exiting the building is replaced by other air from within the building that enters the building through doors or windows. As such, conditioned air is used and exhausted from the building during the drying cycle. However, with the present embodiment, the dryer 210 draws drying air from the room in which it is located, but the air is not replaced by conditioned air from the interior 18 of the building 17, but the ambient air surrounding the dryer is replaced by unconditioned air from the exterior 16 of the building 17.

In this embodiment, the dual flow duct 14 includes both an air supply passage 60 and an air exhaust passage 62 and an air intake and exhaust manifold 252 connected to the dual flow duct 14 external to the dryer 210. The air intake and exhaust manifold 252 includes an exhaust air inlet 263 that is interconnected to dryer's exhaust air outlet 164. As such, exhaust air 244 exhausted from the dryer 210 is exhausted through the air intake and exhaust manifold 252 and then the air exhaust passage 62 of the dual flow duct 14, similar to the process as explained previously.

However, the dryer 210 draws the drying air, indicated generally by arrows 240 directly from the ambient air within the interior 18 of the building 17, and more particularly, the room housing the dryer 210. However, the ambient air within the room is not primarily replenished by conditioned air from the rest of the building 17. In this embodiment, the air intake and exhaust manifold 252 includes a drying air outlet 265 that is in fluid communication with the exterior 16 of the building 17 through the air supply passage 60. As such, when the dryer 210 draws drying air 240 from the room for drying the moist goods 19, the air is replaced by air, indicated generally by arrows 241, that is drawn into the building 17 through the duct 14 via a vacuum created by the exhaust air 244 exiting the building 17.

This embodiment can be extremely beneficial as the conditioned air from the rest of the building is not used to continue the drying process. Instead, unconditioned air 241 from the exterior 16 of the building 17 is used. To prevent conditioned air from escaping the building 17 when the dryer 210 is inoperative, the air intake and exhaust manifold 252 includes a damper 267 that can close the drying air outlet 265 of the air intake and exhaust manifold 252 and prevent fluid communication between the interior 18 and exterior 16 of the building 17 via the air supply passage 60 of the dual flow duct 14. The damper 267 may be configured for manual or automatic opening or closing. As such, the damper 267 may be configured to be opened or closed directly by the user or configured to open or close automatically upon activation or deactivation of the dryer 210.

In another embodiment, illustrated in FIG. 6, the air supply passage 360 and the air exhaust passage 362 are configured such that the two passages 360, 362 are side-by-side rather than concentric. In this configuration, a common outer wall 368 provides an outer periphery for the dual flow duct 314 but rather than forming the entire outer periphery of a single passage, like the previously described concentric embodiment, the outer wall 368 forms a portion of both of the air intake and air exhaust passages 360, 362. The dual flow duct 314 further includes a common wall 366 that separates the two passages 360, 362 from one another. Preferably, the common wall 366 is formed from a thermally conductive material such that heat energy can be transferred from the air exhausted through the air exhaust passage to the air being brought into the dryer through the air supply passage. This common wall 366 may further include heat transfer fins 374 to increase the heat transfer between the two passages 360, 362.

It will be recognized by one of ordinary skill in the art that the embodiments of the ducts disclosed previously could be practiced using plastic or other non-thermally conductive material rather than thermally conductive material. However, such configurations will not have the additional benefits of functioning as a heat exchanger. The use of plastic duct could be extremely beneficial when retrofitting existing duct with a second passage by using flexible plastic duct that can be more easily inserted through the existing ductwork. FIG. 7 illustrates an embodiment where the dual flow duct 414 is formed by an existing duct 451 that is rectangular and the inner duct 466 is formed by circular plastic flexible duct. As discussed previously, the dual flow duct 414 includes an air supply passage 460 and an air exhaust passage 462.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A combined supply and exhaust apparatus for an air using appliance comprising:
an air supply passage extending between a supply inlet and a supply outlet, the air supply passage supplying air to the appliance;
an air exhaust passage extending between an exhaust inlet and an exhaust outlet, the air exhaust passage exhausting air from the appliance; and
a common wall separating the air supply passage from the air exhaust passage by a common wall.

2. The combined supply and exhaust apparatus of claim 1, wherein the air supply and air exhaust passages are concentric and the air supply passage is positioned radially outward beyond the air exhaust passage.

3. The combined supply and exhaust apparatus of claim 1, wherein the air supply and air exhaust passages are side-by-side.

4. The combined supply and exhaust apparatus of claim 3, wherein the common wall is thermally conductive and includes at least one heat transfer structure.

5. The combined supply and exhaust apparatus of claim 1, wherein the air supply and air exhaust passages are in thermal communication with one another via the common wall.

6. The combined supply and exhaust apparatus of claim 2, further including an outer wall, the air supply passage being disposed between the outer wall and the common wall and the air exhaust passage is disposed entirely within the common wall.

7. The combined supply and exhaust apparatus of claim 6, wherein the common wall is thermally conductive.

8. The combined supply and exhaust apparatus of claim 7, further comprising at least one thermally conductive fin extending from the common wall.

9. The combined supply and exhaust apparatus of claim 8, wherein the at least one thermally conductive fin extends to the outer wall positioning the common wall within the outer wall.

10. The combined supply and exhaust apparatus of claim 1, further comprising an outer wall, the common wall being formed of flexible duct pipe and being inserted within the outer wall.

11. The combined supply and exhaust apparatus of claim 1, wherein the first flow passage includes a vent interposed between the air supply inlet and air supply outlet, the vent including a damper for selectively opening and closing the vent.

12. The combined supply and exhaust apparatus of claim 1, further comprising a damper positioned proximate the air supply outlet, wherein the damper selectively opens and closes the air supply outlet.

13. The combined supply and exhaust apparatus of claim 10, wherein the outer wall is provided by a pre-existing duct in a building, the common wall being inserted within the pre-existing duct.

14. The combined supply and exhaust apparatus of claim 1, further comprising a first air intake and exhaust manifold mounted to the air supply and air exhaust passages, the first air intake and exhaust manifold having the air supply outlet and air exhaust inlet formed therein.

15. The combined supply and exhaust apparatus of claim 3, wherein the air supply passage is defined by a first combination of the common wall and the outer wall and the air exhaust passage is defined by a second combination of the common wall and the outer wall.

16. The combined supply and exhaust apparatus of claim 14, further comprising a second air intake and exhaust manifold having the air exhaust outlet and air supply inlet formed therein.

17. A combined supply and exhaust apparatus for an air using appliance comprising:
an air flow duct having first and second air flow passages being separated by a common wall;
a first intake and exhaust manifold mounted to a first end of the air flow duct, the first intake and exhaust manifold forming a first outlet of the first flow passage and a second inlet of the second flow passage;
a second intake and exhaust manifold mounted to an opposite end of the air flow duct, the second intake and exhaust manifold forming a first inlet of the first flow passage and a second outlet of the second flow passage.

18. The combined supply and exhaust apparatus of claim 17, wherein the common wall is formed from a thermally conductive material and includes a heat transfer structure.

19. The combined supply and exhaust apparatus of claim 18, further comprising an outer wall, wherein the outer wall and common wall are concentrically aligned.

20. The combined supply and exhaust apparatus of claim 19, further comprising a plurality of heat transfer fins extending from the common wall, at least one heat transfer fin extending into the first air flow passage and at least one heat transfer fin extending into the second air flow passage.

21. The combined supply and exhaust apparatus of claim 20, wherein the second intake and exhaust manifold substantially prevents debris from entering the first and second flow passages through the first inlet and second outlet, respectively.
